(19) United States
(12) Patent Application Publication
(10) Pub. No.: US 2012/0231892 A1
(43) Pub. Date: Sep. 13, 2012

(54) SPRING-LOADED HELICAL COUPLING MECHANISM

(76) Inventor: Jose Maria Las Navas Garcia, Conway, SC (US)

(21) Appl. No.: 13/400,739

(22) Filed: Feb. 21, 2012

Related U.S. Application Data
(60) Provisional application No. 61/450,671, filed on Mar. 9, 2011.

(51) Int. Cl. F16D 3/00

(52) U.S. Cl. 464/61.1

(57) ABSTRACT

A spring-loaded coupling mechanism includes a cylindrical housing having a top and bottom end, a cylindrical interior cavity defining a top and bottom opening, and at least one uniformly integrated spiral coil. The housing includes a plurality of slots adjacent the top and bottom ends, including front slots, back slots and circumferential slots for allowing the ends of the housing to compress. A spring is inserted within the interior cavity and secured by a pair of cylindrical clamps, including a first clamp inserted within the top opening of the interior cavity and a second clamp inserted within the bottom opening of the interior cavity. A securing means includes a pair of threaded screw cavities that extend horizontally through the housing, one positionable near the top end and the other near the bottom end for securing the spring within the housing.

### CROSS-REFERENCE TO RELATED APPLICATION

This application claims the benefit of provisional patent application Ser. No. 61/450,671 filed in the United States Patent and Trademark Office on Mar. 9, 2011.

### BACKGROUND OF THE INVENTION

1. Field of the Invention

This invention relates generally to coupling mechanisms and more particularly to a spring-loaded helical coupling mechanism that is capable of coupling together two objects such as a motor to a shaft in an analyzer testing device.

2. Description of the Related Art

Aluminum couplings have long been used for connecting together different objects, specifically shafts, for the transmittal of power. While connecting two pieces of rotating equipment, they specifically provide for some amount of misalignment or end movement or both. A variety of different couplings, including rigid and flexible, are available for providing specifications sought. In particular, beam couplings, also known as helical couplings, are flexible couplings, which transmit torque between two objects, such as shafts, while permitting angular misalignment, parallel offset and even axial motion of the shafts relative to one another.

However, conventional helical couplings tend to expand and contract due the mass moving as the motor rotates in a single directing, thereby creating an undesirable push-pull movement.

While these units may be suitable for the particular purpose employed, or for general use, they would not be as suitable for the purposes of the present invention as disclosed hereafter.

The helical coupling of the present invention utilizes a spring-loaded mechanism thus increasing efficiency and reducing vibration while still maintaining adequate flexibility. In the preferred embodiment of the present invention the spring-loaded helical coupling is used in an analyzer for moisture or ash testing which employees a rotatable and vertically movable carousel. The carousel is designed to carry multiple crucibles with test samples. Such an analyzer is disclosed in commonly owned U.S. Pat. No. 7,172,729, which is incorporated by reference herein.

It is, therefore, a primary object of the present invention to provide an improved helical coupling having a spring-loaded mechanism therein.

It is another object of the present invention to provide a helical coupling mechanism capable of coupling within any two objects including a motor and shaft.

It is another object of the present invention to provide a helical coupling mechanism capable of compressing in order to accommodate coupling with two misaligned objects.

It is another object of the present invention to provide a helical coupling capable of increasing efficiency, reducing vibration and maintaining flexibility while connecting together two objects.

It is another object of the present invention to provide a helical coupling capable of withstanding larger loads and breaking less easily.

### BRIEF SUMMARY OF THE INVENTION

In accordance with one aspect of the present invention, a helical coupling mechanism is provided with an integrated spring-loaded mechanism.

The coupling mechanism includes a cylindrical housing having a top end, bottom end, front portion and a substantially cylindrical interior cavity centrally positioned within the housing and defining a substantially circular top opening at the top end and a substantially circular bottom opening at the bottom end. The cylindrical interior cavity extends vertically throughout the housing from the top opening to the bottom opening. The housing includes at least one spiral coil uniformly integrated therein.

The coupling mechanism includes a connecting means extending and securing with the cylindrical housing and that includes a first and second shaft. The first shaft is attached to an object at the top opening, and the second shaft is attached to another object at the bottom opening.

The coupling mechanism includes a compression means integrated within the housing that includes a plurality of machined slots adjacent the top and bottom ends, such that the housing is able to compress and misalign the top and bottom ends.

The coupling mechanism includes a removably coupled spring-loaded mechanism for decreasing the extension of the coupling, with the inclusion of a compression spring inserted within the interior cavity of the housing. The mechanism includes a pair of cylindrical clamps, including a first clamp inserted within the top opening of the interior cavity, and a second clamp inserted within the bottom opening of the interior cavity.

The coupling mechanism includes a securing means that releasably and securably retains the spring-loaded mechanism and the connecting means within the interior cavity of the housing.

The interior cavity of the coupling mechanism is created by a lathe and has a uniform diameter from the top end to the bottom end.

The housing of the coupling mechanism includes a plurality of spiral coils centrally positioned between the top end and bottom end of the housing.

The securing means of the coupling mechanism includes a pair of substantially cylindrical threaded screw cavities that extend horizontally through the cylindrical housing. A first cavity is positionable near the top end and a second cavity is positionable near the bottom end of the housing.

The coupling mechanism includes a pair of screws, wherein one screw is removably screwed within each threaded screw cavity for securing the spring-loaded mechanism and connecting means within the housing. The cavities are positionable along a common plane within the front side of the housing.

The plurality of slots of the compression means include at least three slots adjacent the top end and at least three slots adjacent the bottom end of the housing. The two front slots are positionable at the front surface of the housing, one at the top end and the other at the bottom end of the housing and they extend perpendicular to the threaded screw cavities entirely through the housing from the interior cavity. Two partial back slots are opposite the front slots in a parallel orientation within the housing and extend outwardly from the interior cavity only partially through the housing. Two circumferential slots machined within the housing extend circumferentially around the housing perpendicular the front slots.

The compression spring is inserted within the interior cavity of the housing by pressure means.

In accordance with another aspect of the present invention, a coupling mechanism is provided that includes a cylindrical housing having a top end, bottom end, front portion and a substantially cylindrical interior cavity centrally positioned within the housing and defining a substantially circular top opening at the top end and a substantially circular bottom opening at the bottom end. The cylindrical interior cavity extends uniformly and vertically throughout the housing from the top opening to the bottom opening. The housing including at least one spiral coil uniformly integrated therein and centrally positionable between the top and bottom ends of the housing. The coupling mechanism includes a connecting means extending and securing within the cylindrical housing, and having a first and second shaft, wherein the first shaft is attachable to an object at the top opening, and the second shaft is attachable to another object at the bottom opening. The coupling mechanism includes a compression means integrated within the housing, including a plurality of machined slots adjacent the top and bottom ends, including at least three slots adjacent the top end and at least three slots adjacent the bottom end of the housing, such that the housing is able to compress and misalign the top and bottom ends. The coupling mechanism includes a removably coupled spring-loaded mechanism for decreasing extension of the coupling. The spring-loaded mechanism includes a compression spring inserted within the interior cavity of the housing, and a pair of cylindrical clamps including a first clamp inserted within the top opening of the interior cavity and a second clamp inserted within the bottom opening of the interior cavity. The coupling mechanism includes a securing means for releasably and securably retaining the spring-loaded mechanism and connecting means within the interior cavity of the housing. The securing means of the coupling mechanism includes a parallel pair of substantially cylindrical threaded screw cavities extending horizontally through the housing, wherein a first cavity is positionable near the top end and a second cavity is positionable near the bottom end of the housing.

The coupling mechanism includes a pair of screws, wherein one screw is removably screwed within each threaded screw cavity for securing the spring-loaded mechanism and connecting means within the housing. The compression means includes two front slots positionable at the front surface of the housing, one at the top end and the other at the bottom end of the housing and extending perpendicular to the threaded screw cavities entirely through the housing from the interior cavity. Two partial back slots are opposite the front slots in a parallel orientation within the housing and extend outwardly from the interior cavity only partially through the housing. Two circumferential slots machined within the housing extend circumferentially around the housing perpendicular the front slots.

In accordance with another aspect of the present invention, an attachment mechanism is provided including a conventional helical coupling having an interior cavity including a top opening and a bottom opening. The attachment mechanism includes a removably coupled spring-loaded mechanism for decreasing extension of the coupling. The spring-loaded mechanism includes a compression spring inserted within the interior cavity and a pair of cylindrical clamps including a first clamp inserted within the top opening of the interior cavity and a second clamp inserted within the bottom opening of the interior cavity.

### BRIEF DESCRIPTION OF THE SEVERAL VIEWS OF THE DRAWINGS

To these and to such other objects that may hereinafter appear, the present invention related to a helical coupling having a spring-loaded mechanism as described in detail in the following specification and recited in the annexed claims, taken together with the accompanying drawings, in which like numerals refer to like parts in which:

FIG. 1 is an isometric view of a helical coupling of the present invention including a spring-loaded mechanism within an interior cavity of the coupling;

FIG. 2 is a top elevational view of the spring-loaded helical coupling mechanism of FIG. 1; and

FIG. 3 is an isometric view of the spring-loaded helical coupling mechanism of FIG. 1 having connecting means.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

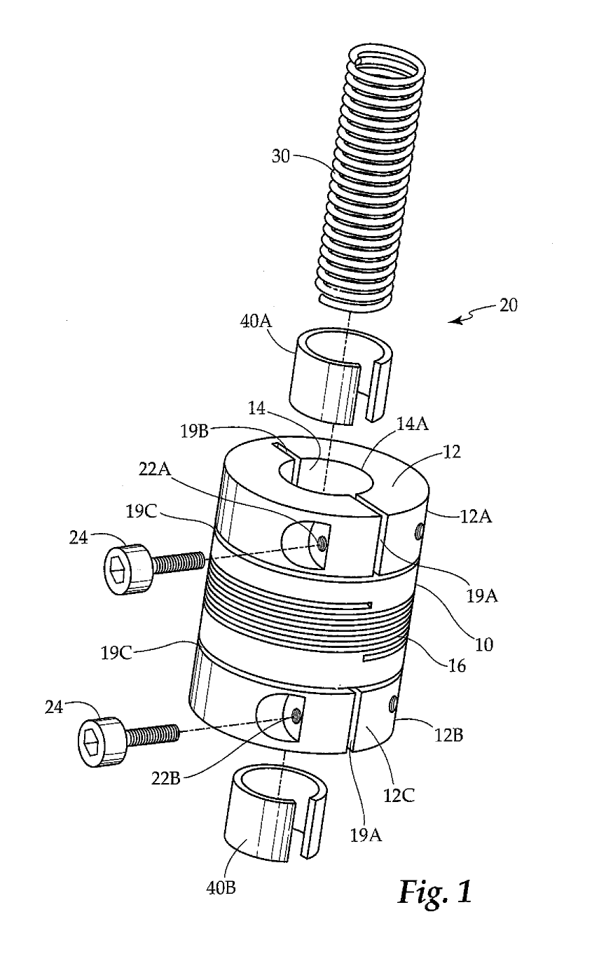

As seen in FIGS. 1 through 3, the preferred embodiment of the present invention is a helical coupling 10 having a removably coupled spring-loaded mechanism 20. The coupling 10 includes vast improvements over prior art couplings by adding spring-loaded mechanism advantages, thereby utilizing a spring to increase efficiency, maintain flexibility, and decrease unnecessary movement.

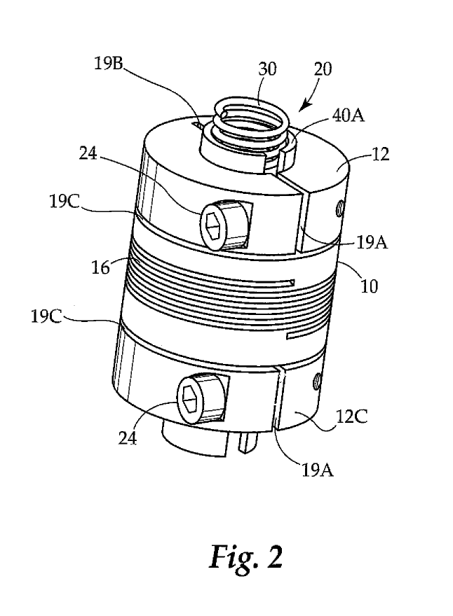

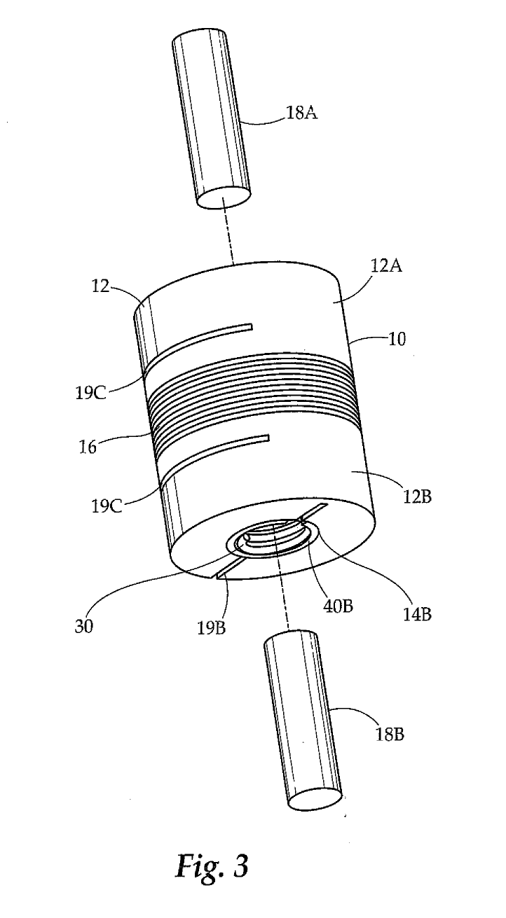

As is best appreciated from FIGS. 1 and 2, the spring-loaded mechanism 20 is removably housed within the helical coupling 10. The helical coupling 10 includes a cylindrical housing 12, including a substantially cylindrical interior cavity 14 centrally positioned within the housing 12 and created from a lathe. The cylindrical interior cavity 14 extends vertically throughout the housing 12 from a top end 12A to a bottom end 12B, and defines a substantially circular top opening 14A at the top end 12A, and a substantially circular bottom opening 14B at the bottom end 12B (shown in FIG. 3). The interior cavity 14 preferably has a uniform diameter from the top opening 14A to the bottom opening 14B. The housing 12 further includes a front portion 12C.

A connecting means, illustrated in FIG. 3, including a pair of shafts 18 attach or connect the coupling 10 by conventional means, to an object, which is capable of being attached to another object. Specifically, a first shaft 18A attaches or connects an object to the top opening 14A of the interior cavity 14, while a second shaft 18B attaches or connects another object to the bottom opening 14B of the interior cavity 14.

The housing 12 of the helical coupling 10 includes spiral coils 16 machined therein, and preferably centrally positioned between the top end 12A and bottom end 12B of the housing 12. The spiral coils 16 are designed to accommodate angular and parallel misalignment, axial motion, and system vibrations and thus a variety of alternate configurations are contemplated. The geometry of the coils 16, as well as the material and thickness of the housing 12 of the coupling 10, may be varied in order to optimize performance in a given application.

A compression means is integrated within the housing 12 of the coupling 10, preferably at the top end 12A and bottom end 12B, such that the housing 12 is able to compress the top and bottom ends 12A, 12B respectively. A plurality of slots 19 are machined within the housing 12, and allow the top end 12A and bottom end 12B of the housing 12 to compress. In the preferred embodiment a compression means of three slots work in conjunction to allow compression. Specifically, two front slots 19A are positionable at the front surface 12C of the housing. One of the front slots 19A is at the top end 12A of the housing 12 and the other front slot 19A is at the bottom end 12B of the housing 12. The front slots 19A extend perpendicular the threaded screw cavities 22 entirely through the housing 12 from the interior cavity 14. Partial back slots 19B are opposite the front slots 19A in the housing 12, but are machined therethrough in a parallel fashion. The partial back slots 19B only extend outwardly from the interior cavity 14 part of the way through the housing 12 and allow the front slots 19A at the ends 12A, 12B to fully compress the width of the slot as the screw 24 is threaded. Further, two circumferential slots 19C are machined within the housing 12, and extend circumferentially around the entire housing 12 perpendicular the front slots 19A. The front slots 19A in conjunction with the partial back slots 19B and circumferential slots 19C allow the screws 24 to thread within the threaded cavities 22 and compress together the top and bottom ends 12A, 12B of the housing 12 respectively, such that ends 12A, 12B are not perfectly aligned and thus are able to connect objects together that are misaligned.

A securing means including a pair of substantially cylindrical threaded screw cavities 22 extend horizontally through the housing 12. Preferably, one cavity 22A is positionable near the top end 12A and the other cavity 22B near the bottom end 12B of the housing 12. Preferably, both cavities 22A, 22B are along the front side 12C of the housing 12 and extend entirely through the housing 12 without interfering or contacting the interior cavity 14. A pair of screws 24, preferably socket head cap screws or set-screws, are removably screwed within the threaded cavities 22A, 22B and used to secure the connecting means 18 and spring-loaded mechanism 20 within the housing 12.

The spring-loaded mechanism 20 of the present invention includes a compression spring 30. When the spring 30 is inserted into the interior cavity 14, preferably by pressure means. The spring 30 is substantial equal in length to the length of the coupling 10 (as shown in FIG. 3).

The spring-loaded mechanism 20 of the present invention, further includes pair of cylindrical connecting clamps 40, preferably equal in diameter with the diameter of the interior cavity 14. The clamps 40 are inserted within the interior cavity, as shown in FIGS. 2 and 3. The first clamp 40A is positionable within the top opening 14A of the interior cavity 14 at the top end 12A of the housing 12, while the second clamp 14B is positionable within the bottom opening 14B of the interior cavity 14 at the bottom end 12B of the housing.

Once the spring 30 is entirely inserted within the interior cavity 14, as illustrated in FIG. 3, the two clamps 40 within each respective opening 14A, 14B of each end 12A, 12B of the housing 12 are tightened to compress the spring 30 such that the top and bottom ends 12A, 12B are misaligned. In addition, the clamps 40 fix the spring 30 at its ends, and also prohibit the spring from contacting the interior cavity 14 or housing 12. The spring 30 is free to compress in the middle region where the spring is not in contact with the clamps 40. This provides the coupling 10 with beneficial attributes capable of allowing the coupling 10 to behave like a larger single convention helical coupling. It further reduces the undesirable push-pull movement when the coupling is in use, and will also reduce vibration, while remaining flexible, thus increasing the life expectancy. In alternate embodiments, a machine coupling is contemplated having a step with a larger diameter in the spring compression area, such that the spring avoids contact with the housing 12.

Referring to the present invention in use, wherein the coupling 10 having the spring-loaded mechanism 20, is positioned for use in an analyzer device for moisture or ash testing. Here, the coupling 10 with spring loaded mechanism 20, couples together by conventional means an object, such a shaft or motor, to another object, such as another shaft, which together drive the carousel of the analyzer up and down along a slide in an efficient manner by decreasing undesirable movement. The heavy carousel, filled with crucibles, would previously expand and contract due to the mass thereon being moved as the motor rotates in one single direction creating an undesirable push-pull movement of the carousel. With the inclusion of the spring-loaded mechanism 20, the improved coupling 10 eliminates unwanted extension or movement and provides a tremendously more efficient device when moving the mass of the carousel.

In conclusion, herein is presented a spring-loaded helical coupling mechanism. The invention is illustrated by example in the drawing figures, and throughout the written description. It should be understood that numerous variations are possible, while adhering to the inventive concept. Such variations are contemplated as being a part of the present invention. While only a limited number of preferred embodiments of the present invention have been disclosed for purposes of illustration, it is obvious that many modifications and variations could be made thereto. It is intended to cover all of those modifications and variations, which fall within the scope of the present invention as defined by the following claims.

We claim:

1. A coupling mechanism, comprising:
a cylindrical housing having a top end, bottom end, front portion and a substantially cylindrical interior cavity centrally positioned within said housing and defining a substantially circular top opening at said top end and a substantially circular bottom opening at said bottom end, wherein said cylindrical interior cavity extends vertically throughout said housing from said top opening to said bottom opening, said housing including at least one spiral coil uniformly integrated therein;
a connecting means extending and securing within said cylindrical housing for attaching said housing at said top opening to a first object and attaching said housing at said bottom opening to a second object;
a compression means integrated within said housing, including a plurality of machined slots adjacent said top and bottom ends, such that said housing is able to compress and misalign said top and bottom ends;
a removably coupled spring-loaded mechanism for decreasing extension of said coupling, including a compression spring inserted within said interior cavity of said housing, said mechanism including a pair of cylindrical clamps including a first clamp inserted within said top opening of said interior cavity and a second clamp inserted within said bottom opening of said interior cavity; and
a securing means for releasably and securably retaining said spring-loaded mechanism and said connecting means within said interior cavity of said housing.

2. The coupling mechanism of claim 1, wherein the cylindrical interior cavity is created by a lathe.

3. The coupling mechanism of claim 1, wherein the cylindrical interior cavity has a uniform diameter from the top end to the bottom end.

4. The coupling mechanism of claim 1, wherein a plurality of spiral coils is centrally positioned between the top end and bottom end of the housing.

5. The coupling mechanism of claim 1, wherein the connecting means includes a first and second shaft, wherein said first shaft being attachable to the first object at the top opening, and said second shaft being attachable to the second object at the bottom opening;

6. The coupling mechanism of claim 1, wherein the securing means includes a pair of substantially cylindrical threaded screw cavities extend horizontally through said cylindrical housing, wherein a first said cavity is positionable near said top end and a second cavity is positionable near said bottom end of said housing.

7. The coupling mechanism of claim 6, further comprising a pair of screws, wherein one screw is removably screwed within each threaded screw cavity for securing the spring-loaded mechanism and connecting means within the housing.

8. The coupling mechanism of claim 7, wherein said cavities are positionable along a common plane within the front side of the housing.

9. The coupling mechanism of claim 8, wherein the plurality of slots of the compression means include at least three slots adjacent the top end and at least three slots adjacent the bottom end of the housing.

10. The coupling mechanism of claim 9, wherein two front slots are positionable at the front surface of the housing, one near the top end and the other near the bottom end of the housing and extend perpendicular to the threaded screw cavities entirely through the housing from the interior cavity, wherein two partial back slots are opposite the front slots in a parallel orientation within the housing and extend outwardly from the interior cavity only partially through the housing, wherein two circumferential slots machined within the housing extend circumferentially around the housing perpendicular the front slots.

11. The coupling mechanism of claim 1, wherein the compression spring is inserted within said interior cavity of said housing by pressure means.

12. A coupling mechanism, comprising:
a cylindrical housing having a top end, bottom end, front portion and a substantially cylindrical interior cavity centrally positioned within said housing and defining a substantially circular top opening at said top end and a substantially circular bottom opening at said bottom end, wherein said cylindrical interior cavity extends uniformly and vertically throughout said housing from said top opening to said bottom opening, said housing including at least one spiral coil uniformly integrated therein and centrally positionable between said top and bottom ends of said housing;
a connecting means extending and securing within said cylindrical housing, said connecting means including a first and second shaft, wherein said first shaft being attachable to an object at said top opening, and said second shaft being attachable to another object at said bottom opening;
a compression means integrated within said housing, including a plurality of machined slots adjacent said top and bottom ends, including at least three slots adjacent said top end and at least three slots adjacent said bottom end of said housing, such that said housing is able to compress and misalign said top and bottom ends;
a removably coupled spring-loaded mechanism for decreasing extension of said coupling, including a compression spring inserted within said interior cavity of said housing, said mechanism including a pair of cylindrical clamps including a first clamp inserted within said top opening of said interior cavity and a second clamp inserted within said bottom opening of said interior cavity; and
a securing means for releasably and securably retaining said spring-loaded mechanism and said connecting means within said interior cavity of said housing, including a parallel pair of substantially cylindrical threaded screw cavities extending horizontally through said housing, wherein a first said cavity is positionable near said top end and a second cavity is positionable near said bottom end of said housing.

13. The coupling mechanism of claim 12, further comprising a pair of screws, wherein one screw is removably screwed within each threaded screw cavity for securing the spring-loaded mechanism and connecting means within the housing.

14. The coupling mechanism of claim 12, wherein the compression means includes two front slots positionable at the front surface of the housing, one near the top end and the other near the bottom end of the housing and extending perpendicular to the threaded screw cavities entirely through the housing from the interior cavity, wherein two partial back slots are opposite the front slots in a parallel orientation within the housing and extend outwardly from the interior cavity only partially through the housing, wherein two circumferential slots machined within the housing extend circumferentially around the housing perpendicular the front slots.

15. An attachment mechanism, comprising:
a conventional helical coupling including an interior cavity having a top opening and a bottom opening; and
a removably coupled spring-loaded mechanism for decreasing extension of said coupling, including a compression spring inserted within said interior cavity, said mechanism including a pair of cylindrical clamps including a first clamp inserted within said top opening of said interior cavity and a second clamp inserted within said bottom opening of said interior cavity.
